(19) United States
(12) Patent Application Publication
(10) Pub. No.: US 2018/0079917 A1
(43) Pub. Date: Mar. 22, 2018

(54) HEAT INSULATION PAINT

(71) Applicant: FUJIFILM CORPORATION, Tokyo (JP)

(72) Inventor: Naoharu KIYOTO, Shizuoka (JP)

(21) Appl. No.: 15/823,623

(22) Filed: Nov. 28, 2017

Related U.S. Application Data
(63) Continuation of application No. PCT/JP2016/070458, filed on Jul. 11, 2016.

(30) Foreign Application Priority Data
Jul. 31, 2015 (JP) 2015-152473

(51) Int. Cl. C09D 7/12; C09D 5/33; C09D 5/24; C09D 165/00; C09D 133/20; G02B 5/20; G02B 5/26

(52) U.S. Cl. CPC C09D 7/1216; C09D 5/004; C09D 7/1291; C09D 5/24; C08K 2003/0806; C09D 165/00; C09D 133/20; G02B 5/208; G02B 5/26; C09D 7/1225

(57) ABSTRACT

A heat insulation paint includes fibrous conductive particles and a binder that would exhibit an average transmittance of 50% or more for far infrared rays having a wavelength of 5 μm to 25 μm when the binder is formed into a coated film having a film thickness of 2 μm, and the content of the fibrous conductive particles with respect to the total solid content is from 2% by mass to 30% by mass.

### CROSS-REFERENCE TO RELATED APPLICATIONS

This application is a continuation application of International Application No. PCT/JP2016/070458, filed Jul. 11, 2016, the disclosure of which is incorporated herein by reference in its entirety. Further, this application claims priority from Japanese Patent Application No. 2015-152473, filed Jul. 31, 2015, the disclosure of which is incorporated herein by reference in its entirety.

### BACKGROUND OF THE INVENTION

### 1. Field of the Invention

The present invention relates to a heat insulation paint.

### 2. Description of the Related Art

In recent years, as one of energy saving measures for reducing air conditioning load so as to reduce an emission amount of carbon dioxide, a heat insulation paint for forming a heat insulation layer on windows of automobiles and buildings, walls of buildings, and the like has been developed.

As the heat insulation paint, a paint for forming a heat ray-absorbing material type heat insulation layer that re-radiates absorbed heat rays (typically radiates an amount of about ⅓ of the energy of the absorbed heat rays), and a paint for forming a heat ray reflective type heat insulation layer are known. From the viewpoint of heat insulation efficiency, the paint for forming a heat ray reflective type heat insulation layer is preferable.

In addition, in a case of considering application to windows of automobiles and buildings, a paint having a high level of transparency and heat insulation efficiency is required.

In the related art, various heat insulation paints have been proposed.

For example, JP2012-252172A discloses a heat ray-shielding film having a heat ray reflective layer on a surface of a transparent film. As a coating solution for forming the heat ray reflective layer, a heat insulation paint containing metal nanofibers and a binder resin is disclosed in JP2012-252172A.

JP2009-108222A discloses a heat insulation paint containing nano hollow particles composed of a silica shell having an outer diameter within a range of approximately 30 nm to approximately 300 nm and containing a binder resin such as an acrylic urethane resin.

### SUMMARY OF THE INVENTION

In the heat insulation paint disclosed in JP2012-252172A, the binder resin absorbs radio waves (for example, electromagnetic waves having a frequency of 2.5 GHz or less). Therefore, for example, in a case where the heat ray-shielding film disclosed in JP2012-252172A is attached to a window glass, permeability of radio waves used for communication of mobile phones is deteriorated, which causes a problem in speech quality on the mobile phones.

In the heat insulation paint disclosed in JP2009-108222A, because reflectivity of far infrared rays by hollow particles is low, it is required to make a thickness of the heat insulation layer thick for lowering the heat transfer coefficient so as to satisfy a function as the heat insulation layer. Furthermore, the heat insulation paint of JP2009-108222A has a low level of transparency, and thus is not suitable for application to windows requiring transparency.

An object of one embodiment of the present invention is to provide a heat insulation paint which has a high level of reflection efficiency of far infrared rays, excellent heat insulation property, and excellent radio wave permeability.

Specific means for solving the problem includes the following aspects.

<1> A heat insulation paint, comprising: fibrous conductive particles; and a binder that would exhibit an average transmittance of 50% or more for far infrared rays having a wavelength of 5 μm to 25 μm when the binder is formed into a coated film having a film thickness of 2 μm,

in which a content of the fibrous conductive particles with respect to the total solid content is from 2% by mass to 30% by mass.

<2> The heat insulation paint according to <1>, in which the heat insulation paint would exhibit a surface electrical resistance of 1000Ω/square or more when the heat insulation paint is formed into a coated film having a film thickness of 500 nm.

<3> The heat insulation paint according to <1> or <2>, in which an average long axis length of the fibrous conductive particles is from 5 μm to 50 μm.

<4> The heat insulation paint according to <3>, in which an average long axis length of the fibrous conductive particles is from 5 μm to 20 μm.

<5> The heat insulation paint according to any one of <1> to <4>, in which a content of the fibrous conductive particles is from 5% by mass to 25% by mass with respect to the total solid content.

<6> The heat insulation paint according to any one of <1> to <5>, in which the binder includes at least one inorganic oxide binder selected from silicon oxide, zirconium oxide, titanium oxide, and aluminum oxide, and a content of the inorganic oxide binder exceeds 50% by mass with respect to the total content of the binder contained in the heat insulation paint.

<7> The heat insulation paint according to any one of <1> to <5>, in which the binder includes at least one organic polymer binder selected from polycycloolefin or polyacrylonitrile, and a content of the organic polymer binder exceeds 50% by mass with respect to the total content of the binder contained in the heat insulation paint.

<8> The heat insulation paint according to any one of <1> to <6>, further comprising: a metal coupling agent having a functional group capable of interacting with the fibrous conductive particles.

<9> The heat insulation paint according to any one of <1> to <8>, in which when the heat insulation paint is diluted 10-fold, a ratio of an average secondary particle diameter a of the fibrous conductive particles before dilution to an average secondary particle diameter b of the fibrous conductive particles after dilution would be from 0.8 to 1.2.

<10> The heat insulation paint according to any one of <1> to <9>, in which fibrous conductive particles include silver nanowires.

According to one embodiment of the present invention, a heat insulation paint having a high level of reflection efficiency of far infrared rays, excellent heat insulation property, and excellent radio wave permeability is provided.

### DESCRIPTION OF EMBODIMENTS

Hereinafter, a heat insulation paint according to the embodiment of the present invention will be described in detail.

In the present specification, the term “(meth)acrylate” means inclusive of both acrylate and methacrylate. For example, the term “methyl (meth)acrylate” includes both methyl acrylate and methyl methacrylate.

Similarly, “(meth)acryl” means inclusive of both acrylic and methacrylic. For example, the term “(meth)acrylic acid” includes both acrylic acid and methacrylic acid, and the term “(meth)acrylamide” includes both acrylamide and methacrylamide.

In the present invention, the term “heat insulation” means a property of reflecting far infrared rays having a wavelength of 5 μm to 25 μm at an average reflectivity of 5% or more. The average reflectivity by which far infrared rays are reflected is preferably 7% or more, more preferably 8% or more, and still more preferably 10% or more.

The average reflectivity of far infrared rays is a value obtained from a reflection spectrum measured with, for example, a Fourier transform infrared spectrophotometer (FT-IR) or the like.

The heat insulation paint according to the embodiment of the present invention includes fibrous conductive particles, and a binder that would exhibit an average transmittance of 50% or more for far infrared rays having a wavelength of 5 μm to 25 μm when the binder is formed into a coated film having a film thickness of 2 μm,

in which the content of the fibrous conductive particles with respect to the total solid content is from 2% by mass to 30% by mass.

The reason why a heat insulation layer having high reflection efficiency of far infrared rays, excellent heat insulation property, and excellent radio wave permeability can be obtained from the heat insulation paint according to the embodiment of the present invention is presumed as follows.

The heat insulation paint according to the embodiment of the present invention contains fibrous conductive particles. As indicated by the name “conductive particles”, the fibrous conductive particles themselves are conductive. However, since the content of the fibrous conductive particles is from 2% by mass to 30% by mass with respect to the total solid content of the heat insulation paint, the heat insulation layer formed by using the heat insulation paint has low conductivity.

Furthermore, the binder contained in combination with the fibrous conductive particles is a binder that would exhibit an average transmittance of 50% or more for far infrared rays having a wavelength of 5 μm to 25 μm when the binder is formed into a coated film having a film thickness of 2 μm.

With the combination of the above two technical features, a specific effect is exhibited, by which the heat insulation layer in which the reflection efficiency of far infrared rays is high, and which has excellent heat insulation property and excellent radio wave permeability as a result, is obtained.

[Fibrous Conductive Particle]

The fibrous conductive particles are fibrous particles having conductivity.

The term “fibrous” includes particles having a wire-like or linear-like shape or a rod-like shape. In addition, the phrase “particles having conductivity” refers to particles in which, in a case where a pellet having a thickness of 0.01 mm or more is produced by drying and solidifying the fibrous particles, a resistance value between one end surface and the other end surface of the pellet is 10Ω or less. The resistance value is a value measured with a noncontact resistance meter (EC-80, manufactured by NAPSON).

Examples of the fibrous conductive particles include fibrous metal particles such as metal nanowires and rod-like metal particles, carbon nanotubes, and conductive resins. The fibrous conductive particles are preferably metal nanowires. The “metal nanowire” refers to a metal particle having conductivity and having a shape in which a long axis length is longer than a diameter (short axis length) and the short axis length (that is, a length of a cross section orthogonal to a longitudinal direction) is a nano order size.

Hereinafter, the metal nanowire will be explained as a representative example of the fibrous conductive particles in some cases, but the explanation related to the metal nanowire can be applied as a general explanation of the fibrous conductive particles.

From the viewpoint that a more transparent heat insulation layer can be obtained, an average short axis length of the fibrous conductive particles is preferably from 1 nm to 150 nm, for example.

Furthermore, the average short axis length (average diameter) of the fibrous conductive particles is preferably 100 nm or less, more preferably 60 nm or less, and still preferably 50 nm or less from the viewpoint of ease of handling at the time of production. The average short axis length is particularly preferably 25 nm or less from the viewpoint that haze is further improved.

In addition, in a case where the average short axis length is 1 nm or more, a heat insulation layer having excellent oxidation resistance and excellent weather fastness can be easily obtained. The average short axis length is more preferably 5 nm or more, still preferably 10 nm or more, and particularly preferably 15 nm or more.

The average long axis length of the fibrous conductive particles is preferably about the same as a reflective band width of far infrared rays to be reflected from the viewpoint of easily reflecting the far infrared rays to be reflected in the reflective band width. Therefore, from the viewpoint of easily reflecting far infrared rays having a wavelength of 5 μm to 25 μm, the average long axis length of the fibrous conductive particles is preferably 5 μm to 50 μm, more preferably 5 μm to 20 μm, and still more preferably 5 μm to 15 μm.

The average short axis length (average diameter) and the average long axis length of the fibrous conductive particles can be obtained by observing a TEM image or an optical microscope image by using, for example, a transmission electron microscope (TEM) and an optical microscope. Specifically, the average short axis length (average diameter) and the average long axis length of the fibrous conductive particles can be obtained by measuring a short axis length and a long axis length of 300 randomly selected fibrous conductive particles respectively by using a transmission electron microscope (trade name: JEM-2000FX, manufactured by JEOL Ltd.), and using an average value thereof the average short axis length and the average long axis length of the fibrous conductive particles. In this specification, values obtained by this method are adopted. As the short axis length in a case where a cross section of the fibrous conductive particles in a short axis direction is not circular, a length of a longest point among values measured in the short axis direction is used as the short axis length. In addition, in a case where the fibrous conductive particles are curved, a value of a curve length calculated from a radius of a circle having the curve as the arc, and from curvature, is used as the long axis length.

The content of the fibrous conductive particles having a short axis length (diameter) of 150 nm or less and a long axis length of from 5 um to 50 um with respect to the content of all fibrous conductive particles contained in the heat insulation paint is preferably 50% by mass or more, more preferably 60% by mass or more, and still more preferably 75% by mass or more in terms of the metal amount. An upper limit of the content of the fibrous conductive particles having a short axis length (diameter) of 150 nm or less and a long axis length of from 5 μm to 50 μm with respect to the content of all fibrous conductive particles contained in the heat insulation paint, is not particularly limited, and may be 100% by mass.

In a case where a proportion of the fibrous conductive particles having a short axis length (diameter) of 150 nm or less and an average long axis length of from 5 μm to 50 μm is 50% by mass or more, it is possible that, which is preferable, sufficient heat insulation property is obtained and a decrease in haze caused by particles having a long short axis length or particles having a short average long axis length is suppressed. In a case where the conductive particles other than the fibrous conductive particles are not substantially contained in the heat insulation paint, it is possible to avoid a decrease in transparency even in a case of a heat insulation layer having strong plasmon absorption.

A coefficient of variation of the short axis length (diameter) of the fibrous conductive particles contained in the heat insulation paint is preferably 40% or less, more preferably 35% or less, and still more preferably 30% or less.

In a case where the coefficient of variation is 40% or less, a ratio of metal nanowires which are likely to reflect far infrared rays having a wavelength of 5 to 50 μm increases, which is preferable from the viewpoints of transparency and heat insulation property. A lower limit value of the coefficient of variation is not particularly limited, and may be 0% or may be 5%, for example.

The coefficient of variation of the short axis length (diameter) of the fibrous conductive particles can be obtained by measuring a short axis length (diameter) of 300 nanowires randomly selected from an image of the transmission electron microscope (TEM) for example, calculating a standard deviation and an arithmetic mean value, and dividing the standard deviation by the arithmetic mean value.

An aspect ratio of the fibrous conductive particles contained in the heat insulation paint is preferably 10 or more. The aspect ratio means a ratio of the average long axis length to the average short axis length (average long axis length/average short axis length). The aspect ratio can be calculated from the average long axis length and the average short axis length calculated by the above method.

An aspect ratio of the fibrous conductive particles is not particularly limited as long as a ratio is 10 or more, and can be appropriately selected according to the purpose, but is preferably from 10 to 100000, more preferably from 50 to 100000, and still more preferably from 100 to 100000.

In a case where the aspect ratio is 10 or more, a network in which fibrous conductive particles are uniformly dispersed is easily formed, and a heat insulation layer having a high level of heat insulation property can be easily obtained. In addition, in a case where the aspect ratio is 100000 or less, formation of aggregates due to entanglement of the fibrous conductive particles with each other in the heat insulation paint is suppressed, and therefore a stable heat insulation paint can be obtained.

The content of the fibrous conductive particles having an aspect ratio of 10 or more with respect to the total mass of the fibrous conductive particles contained in the heat insulation paint is not particularly limited and is preferably 70% by mass or more, more preferably 75% by mass or more, and most preferably 80% by mass or more. An upper limit of the content of the fibrous conductive particles having an aspect ratio of 10 or more with respect to the total mass of the fibrous conductive particles contained in the heat insulation paint is not particularly limited, and may be 100% by mass or may be 95% by mass, for example.

A shape of the fibrous conductive particles can be selected from arbitrary shapes such as a cylindrical shape, a rectangular parallelepiped shape, a columnar shape having a polygonal cross section, and the like. For applications requiring a high level of transparency, fibrous conductive particles having the cylindrical shape, or the columnar shape in which a polygonal cross section is a pentagon or more and no acute angle is present are preferable.

The cross-sectional shape of the fibrous conductive particles can be confirmed by applying an aqueous dispersion liquid of the fibrous conductive particles on a support, and observing the cross section of the fibrous conductive particles with the transmission electron microscope (TEM).

A metal for forming the fibrous conductive particles is not particularly limited and may be any metal. In addition to one metal type, two or more metals may be used in combination, or an alloy may be used. Among these, fibrous conductive particles formed from a single metal or a metal compound are preferable, and fibrous conductive particles formed from a single metal is more preferable.

As the metal for forming the fibrous conductive particles, at least one metal selected from the group consisting of the 4^{th} period, the 5^{th} period, and the 6^{th} period of the periodic table (IUPAC 1991) is preferable, and at least one metal selected from metals of Group 2 to Group 14 is more preferable, and at least one metal selected from metals of Group 2, Group 8, Group 9, Group 10, Group 11, Group 12, Group 13, or Group 14 is still more preferable. It is particularly preferable that the fibrous conductive particles contain these metals as main components.

Specific examples of the metal include copper, silver, gold, platinum, palladium, nickel, tin, cobalt, rhodium, iridium, iron, ruthenium, osmium, manganese, molybdenum, tungsten, niobium, tantalum, titanium, bismuth, antimony, lead, an alloy containing at least one of these metals, and the like. Among these, copper, silver, gold, platinum, palladium, nickel, tin, cobalt, rhodium, iridium, and an alloy of these metals are preferable, palladium, copper, silver, gold, platinum, tin, and an alloy containing any one of these metals are more preferable, and silver and an alloy containing silver are particularly preferable. The content of silver in the alloy containing silver is preferably 50 mol % or more, more preferably 60 mol % or more, still more preferably 80 mol % or more with respect to the total amount of the alloy. In the alloy containing silver, an upper limit of the content of silver with respect to the total amount of the alloy is not particularly limited, and may be 95 mol % or may be 90 mol %, for example.

The content of the silver nanowires with respect to the mass of all fibrous conductive particles contained in the heat insulation paint is not particularly limited as long as the content does not hinder the effects of the present invention. For example, the content of the silver nanowires is preferably 50% by mass or more, and more preferably 80% by mass or more with respect to the mass of all fibrous conductive particles contained in the heat insulation paint, and it is still more preferable that all total fibrous conductive particles are substantially the silver nanowire. The term “substantially” means that the presence of metal atoms which are inevitably mixed, other than silver is allowed.

As described above, the content of the fibrous conductive particles in the heat insulation paint is set to from 2% by mass to 30% by mass with respect to the total solid content of the heat insulation paint. By setting the content of the fibrous conductive particles to from 2% by mass to 30% by mass, a heat insulation layer having excellent heat insulation property and radio wave permeability can be obtained.

The content of the fibrous conductive particles in the heat insulation paint is preferably from 5% by mass to 25% by mass, because a heat insulation layer having both excellent heat insulation property and radio wave permeability can be obtained, and the content is more preferably from 10% by mass to 25% by mass.

—Method for Producing Fibrous Conductive Particles—

The fibrous conductive particles are not particularly limited and may be produced by any method. In a case where the fibrous conductive particles are fibrous metal particles, it is preferable to produce the fibrous conductive particles by reducing metal ions in a solvent in which a halogen compound and a dispersant are dissolved. Furthermore, it is preferable to perform desalination treatment by a general method after forming the fibrous conductive particles from the viewpoint of dispersibility and temporal stability.

In the case where the fibrous conductive particles are the fibrous metal particles, it is possible to use methods described in JP2009-215594A, JP2009-242880A, JP2009-299162A, JP2010-84173A, JP2010-86714A, and the like.

As the solvent used for producing the fibrous conductive particles, hydrophilic solvents are preferable, and examples thereof include water, alcohol-based solvents, ether-based solvents, ketone-based solvents, and the like. These may be used alone, or two or more kinds thereof may be used in combination.

Examples of the alcohol-based solvents include methanol, ethanol, propanol, isopropanol, butanol, ethylene glycol, and the like.

Examples of the ether-based solvents include dioxane, tetrahydrofuran, and the like.

Examples of the ketone-based solvents include acetone and the like.

In a case of performing heating in the production of the fibrous conductive particles, a heating temperature is preferably 250° C. or less, more preferably 20° C. or higher and 200° C. or lower, still more preferably 30° C. or higher and 180° C. or lower, and particularly preferably 40° C. or higher and 170° C. or lower. By setting the heating temperature to 20° C. or higher, the length of the fibrous conductive particles to be formed becomes a length that falls within a preferable range in which dispersion stability can be secured. Furthermore, by setting the heating temperature to 250° C. or lower, an outer circumference of a cross section of the metal nanowire does not have an acute angle and becomes a smooth shape, and therefore coloration due to surface plasmon absorption of the metal particles is suppressed, which is preferable from the viewpoint of the transparency.

If necessary, the temperature may be changed during a particle formation process, and the change in temperature during the process may exhibit the effect of controlling nucleation, suppressing the regeneration of nucleus, and improving monodispersibility by promoting selective growth.

The heat treatment is preferably carried out by adding a reducing agent.

The reducing agent is not particularly limited and can be appropriately selected from those generally used. Specific examples of the reducing agent include metal borohydride, aluminum hydride salt, alkanolamine, aliphatic amine, heterocyclic amine, aromatic amine, aralkyl amine, alcohols, organic acid, reducing sugar, sugar alcohols, sodium sulfite, hydrazine compounds, dextrin, hydroquinone, hydroxylamine, ethylene glycol, glutathione, and the like. Among these, the reducing sugars, the sugar alcohols as derivatives thereof, and ethylene glycol are particularly preferable.

Depending on the types of the reducing agent, in some cases, the reducing agent are compounds functioning also as a dispersant and a solvent, and such reducing agent can be preferably used in the same manner.

The production of the fibrous conductive particles is preferably carried out by adding a dispersant and a halogen compound or metal halide fine particles in a reaction system.

A timing of adding the dispersant and the halogen compound may be either before or after the addition of the reducing agent and may be either before or after the addition of metal ions or metal halide fine particles, but in order to obtain the fibrous conductive particles with better monodispersibility, it is preferable to add the halogen compound in two or more stages because nucleation and growth can be controlled.

The stage of adding the dispersant is not particularly limited. The dispersant may be added before the preparation of the fibrous conductive particles, and the fibrous conductive particles may be added under the presence of the dispersant. In addition, the dispersant may be added to control a dispersion state after the preparation of the fibrous conductive particles.

Examples of the dispersant include an amino group-containing compound, a thiol group-containing compound, a sulfide group-containing compound, an amino acid or a derivative thereof, a peptide compound, a polysaccharide, a natural polymer derived from a polysaccharide, a synthetic polymer, a polymer compound such as gel derived from these, and the like. Among these, various polymer compounds preferably used as the dispersant are compounds contained in a polymer described below.

Preferred examples of the polymer suitably used as the dispersant include protective colloidal polymers such as gelatin, polyvinyl alcohol, methyl cellulose, hydroxypropyl cellulose, polyalkylene amine, partially alkyl ester of polyacrylic acid, polyvinyl pyrrolidone, a copolymer including a polyvinylpyrrolidone structure, and a polymer having a hydrophilic group such as a polyacrylic acid having an amino group or a thiol group.

In the polymer used as the dispersant, a weight-average molecular weight (Mw) measured by gel permeation chromatography (GPC) is preferably from 3000 to 300000, and more preferably from 5000 to 100000.

For examples of the structure of a compound usable as the dispersant, a description of “Pigment's Dictionary” (edited by Seiji Ito, published by Asakura Publishing Co., Ltd., 2000) can be referred to.

It is possible to change a shape of the metal nanowires obtained depending on the types of the dispersant to be used.

The halogen compound is not particularly limited as long as the compound is a compound containing bromine, chlorine or iodine, and can be appropriately selected according to the purpose. For example, a compound which can be used in combination with alkali halides such as sodium bromide, sodium chloride, sodium iodide, potassium iodide, potassium bromide, and potassium chloride, and the following dispersing additives is preferable.

As the halogen compound, there is a halogen compound that functions as a dispersion additive, but a halogen compound having such function can be preferably used similarly.

Silver halide fine particles may be used as a substitute for the halogen compound, or the halogen compound and the silver halide fine particles may be used together.

Alternatively, a single substance having both the functions of the dispersant and the halogen compound may be used. That is, by using the halogen compound having the function as the dispersant, both the functions of the dispersant and the halogen compound are exhibited with one compound.

Specific examples of the halogen compound having the function of the dispersant include hexadecyl-trimethylammonium bromide (HTAB) containing an amino group and a bromide ion, hexadecyl-trimethylammonium chloride (HTAC) containing an amino group and a chloride ion, dodecyltrimethylammonium bromide containing an amino group and a bromide ion or a chloride ion, dodecyl trimethyl ammonium chloride, stearyl trimethyl ammonium bromide, stearyl trimethyl ammonium chloride, decyl trimethyl ammonium bromide, decyl trimethyl ammonium chloride, dimethyl distearyl ammonium bromide, dimethyl distearyl ammonium chloride, dilauryl dimethyl ammonium bromide, dilauryl dimethyl ammonium chloride, dimethyl dipalmityl ammonium bromide, dimethyl dipalmityl ammonium chloride, and the like.

In the method for producing the fibrous conductive particles, the desalination treatment is preferably performed after the fibrous conductive particles are formed. The desalination treatment after the formation of the fibrous conductive particles can be performed by methods such as ultrafiltration, dialysis, gel filtration, decantation, centrifugation, and the like.

It is preferable that the fibrous conductive particles do not contain inorganic ions such as alkali metal ions, alkaline earth metal ions, halide ions, and the like as much as possible. Electric conductivity of a dispersion obtained by dispersing the fibrous metal particles such as metal nanowires in an aqueous solvent is preferably 1 mS/cm or less, more preferably 0.1 mS/cm or less, and still more preferably 0.05 mS/cm or less.

Viscosity at 25° C. of the aqueous dispersion of the fibrous conductive particles is preferably 0.5 mPa·s to 100 mPa·s, and more preferably 1 mPa·s to 50 mPa·s.

The electric conductivity and the viscosity are measured assuming that a concentration of the fibrous conductive particles in the aqueous dispersion is 0.45% by mass. In a case where a concentration of the fibrous conductive particles in the aqueous dispersion is higher than the above concentration, the measurement is performed by diluting the aqueous dispersion with distilled water.

Specifically, the electric conductivity is a value measured using CM-25R manufactured by DKK-TOA CORPORATION, and the viscosity at 25° C. is a value measured at 25° C. using TVB10 manufactured by TOKI SANGYO CO., LTD.

[Binder]

The heat insulation paint according to the embodiment of the present invention includes a binder (hereinafter also referred to as “specific binder”) that would exhibit an average transmittance of 50% or more for far infrared rays having a wavelength of 5 μm to 25 μm when the binder is formed into a coated film having a film thickness of 2 μm. By including the specific binder in the heat insulation paint according to the embodiment of the present invention, a heat insulation layer having excellent heat insulation property and radio wave permeability can be obtained.

Furthermore, with the specific binder, the dispersion of the fibrous conductive particles in the heat insulation paint is stably maintained, and in a case where the heat insulation paint is applied directly to a surface to be coated such as a glass plate, it is possible to secure strong adhesiveness between the surface to be coated and the heat insulation layer even in a case where the paint is directly applied and not via an adhesive layer.

The heat insulation paint according to the embodiment of the present invention may contain a component other than the specific binder which forms the matrix of the heat insulation layer. The term “matrix” is a generic term for substances containing fibrous conductive particles to form a layer.

As described above, the specific binder may be any binder that would exhibit an average transmittance of 50% or more for far infrared rays having a wavelength of 5 μm to 25 μm when the binder is formed into a coated film having a film thickness of 2 μm. In regard to the phrase “when the binder is formed into a coated film”, not only a case where the coated film itself is the same compound as the binder contained in the heat insulation paint, but also a case where the binder contained in the heat insulation paint and the binder of being the coated film have different chemical structures, is included in the meaning of the specific binder contained in the heat insulation paint according to the embodiment of the present invention. In the following description, the binder contained in the heat insulation paint may be referred distinguishably from a “binder component” in some cases. The average transmittance of the binder may be 60% or more, may be 70% or more, or may be 80% or more. An upper limit value of the average transmittance is not particularly limited, and may be 100%, 99%, 95%, or 90%, for example.

The heat insulation paint of the present invention preferably contains at least one inorganic oxide binder selected from silicon oxide, zirconium oxide, titanium oxide, or aluminum oxide as a binder. In a case where at least one inorganic oxide binder selected from silicon oxide, zirconium oxide, titanium oxide, or aluminum oxide is contained as a binder, in a case where the content of the inorganic oxide binder with respect to the total amount of the binder contained in the heat insulation paint exceeds 50% by mass, it is preferable because a heat insulation layer having particularly excellent heat insulation property and radio wave permeability can be obtained.

Furthermore, the heat insulation paint of the present invention preferably contains, as a binder, at least one organic polymer binder selected from the group consisting of polycycloolefin and polyacrylonitrile. In a case where the heat insulation paint of the present invention contains at least one organic polymer binder selected from the group consisting of polycycloolefin and polyacrylonitrile as a binder, in a case where the content of the organic polymer binder with respect to the total amount of the binder contained in the heat insulation paint exceeds 50% by mass, it is preferable because a heat insulation layer having particularly excellent heat insulation property and radio wave permeability can be obtained.

It is particularly preferable that at least one inorganic oxide binder selected from the group consisting of silicon oxide, zirconium oxide, titanium oxide, and aluminum oxide is a sol-gel cured product formed by a sol-gel reaction.

—Sol-Gel Cured Product—

A sol-gel cured product, which is one of preferred specific examples of the specific binder, is obtained by hydrolyzing and polycondensing an alkoxide compound of an element selected from the group consisting of silicon (Si), zirconium (Zr), titanium (Ti), and aluminum (Al). The sol-gel cured product obtained by hydrolysis and polycondensation of an alkoxide compound of a Si element is particularly preferable the from the viewpoints of production cost and reflectivity in a region of far infrared rays.

The sol-gel cured product obtained by hydrolyzing and polycondensing an alkoxide compound of an element selected from the group consisting of Si, Zr, Ti, and Al (hereinafter also referred to as specific alkoxide compound) is at least one inorganic oxide binder selected from silicon oxide, zirconium oxide, titanium oxide, or aluminum oxide.

One specific example of the heat insulation paint according to the embodiment of the present invention includes a specific alkoxide compound as a specific binder. As the binder, the heat insulation layer formed by using the heat insulation paint containing the specific alkoxide compound, contains, as a binder, the sol-gel cured product obtained by hydrolysis and polycondensation of the specific alkoxide compound.

—Specific Alkoxide Compound—

As the alkoxide compound of Si element, there is a tetrafunctional tetraalkoxysilane. Examples of the tetrafunctional tetraalkoxysilane include tetramethoxysilane, tetraethoxysilane, tetrapropoxysilane, tetrabutoxysilane, methoxytriethoxysilane, ethoxy trimethoxysilane, methoxy tripropoxysilane, ethoxy tripropoxysilane, propoxy trimethoxysilane, propoxy triethoxysilane, dimethoxydiethoxysilane, and the like. Among these, particularly preferred examples thereof can include tetramethoxysilane, tetraethoxysilane, and the like.

Examples of tetrafunctional tetraalkoxy titanate include tetramethoxy titanate, tetraethoxy titanate, tetrapropoxy titanate, tetraisopropoxy titanate, tetrabutoxy titanate, and the like.

Examples of tetrafunctional tetraalkoxyzirconium include zirconate corresponding to a compound exemplified as tetraalkoxy titanate. That is, examples thereof include a compound in which “titanate” in the compound exemplified as tetraalkoxy titanate is replaced with “zirconate”.

Examples of tetrafunctional tetraalkoxyaluminium include aluminate corresponding to a compound exemplified as tetraalkoxy titanate. That is, examples thereof include a compound in which “titanate” in the compound exemplified as tetraalkoxy titanate is replaced with “aluminate”.

Examples of the specific alkoxide compound include an organoalkoxide compound. Specific examples of the organoalkoxide compound are as below, but the present invention is not limited thereto.

Examples of bifunctional organoalkoxysilane can include dimethyldimethoxysilane, diethyldimethoxysilane, propylmethyldimethoxysilane, dimethyldiethoxysilane, diethyldiethoxysilane, dipropyldiethoxysilane, γ-chloropropylmethyldiethoxysilane, γ-chloropropyldimethyldimethoxysilane, chloro dimethyldiethoxysilane, (p-chloromethyl) phenylmethyldimethoxysilane, γ-bromopropylmethyldimethoxysilane, acetoxymethylmethyldiethoxysilane, acetoxymethylmethyldimethoxysilane, acetoxypropylmethyldimethoxysilane, benzoyloxypropylmethyldimethoxysilane, 2-(carbomethoxy) ethyl methyl dimethoxysilane, phenyl methyl dimethoxysilane, phenyl ethyl diethoxysilane, phenyl methyl dipropoxysilane, hydroxymethyl methyl diethoxysilane, N-(methyldiethoxysilylpropyl)-O-polyethylene oxide urethane, N-(3-methyldiethoxysilylpropyl)-4-hydroxybutyramide, N-(3-methyldiethoxysilylpropyl) gluconamide, vinylmethyl dimethoxysilane, vinylmethyl diethoxysilane, vinylmethyl dibutoxysilane, isopropenyl methyl dimethoxysilane, isopropenyl methyl diethoxysilane, isopropenyl methyl dibutoxysilane, vinylmethyl bis(2-methoxyethoxy)silane, allyl methyl dimethoxysilane, vinyl decyl methyl dimethoxysilane, vinyl octyl methyl dimethoxysilane, vinyl phenyl methyl dimethoxysilane, isopropenyl phenyl methyl dimethoxysilane, 2-(meth)acryloxyethylmethyldimethoxysilane, 2-(meth)acryloxyethylmethyldiethoxysilane, 3-(meth)acryloxypropylmethyldimethoxysilane, 3-(meth)acryloxypropylmethyldimethoxysilane, 3-(meth)acryloxypropylmethylbis(2-methoxyethoxy)silane, 3-[2-(allyloxycarbonyl) phenylcarbonyloxy] propylmethyldimethoxysilane, 3-(vinylphenyl amino) propylmethyldimethoxysilane, 3-(vinylphenylamino) propylmethyldiethoxysilane, 3-(vinylbenzylamino) propylmethyldiethoxysilane,

3-(vinylbenzylamino) propylmethyldiethoxysilane, 3-[2-(N-vinylphenylmethylamino) ethylamino] propylmethyldimethoxysilane, 3-[2-(N-isopropenylphenylmethylamino) ethylamino] propyl methyl dimethoxysilane, 2-(vinyloxy) ethylmethyldimethoxysilane, 3-(vinyloxy) propylmethyldimethoxysilane, 4-(vinyloxy) butylmethyldiethoxysilane, 2-(isopropenyloxy) ethylmethyldimethoxysilane, 3-(allyloxy) propylmethyldimethoxysilane, 10-(allyloxycarbonyl) decylmethyldimethoxysilane, 3-(isopropenylmethyloxy) propylmethyldimethoxysilane, 10-(isopropenylmethyloxycarbonyl) decylmethyldimethoxysilane, 3-[(meth)acryloxypropyl] methyldimethoxysilane, 3-[(meth)acryloxypropyl] methyldiethoxysilane, 3-[(meth)acryloxymethyl] methyldimethoxysilane, 3-[(meth)acryloxymethyl] methyldiethoxysilane, γ-glycidoxypropylmethyldimethoxysilane, N-[3 -(meth)acryloxy-2-hydroxypropyl]-3 -aminopropylmethyldiethoxysilane, O-“(meth)acryloxyethyl”-N- methyl diethoxysilylpropyl) urethane, γ-glycidoxypropylmethyldiethoxysilane, β-(3,4-epoxycyclohexyl) ethylmethyldimethoxysilane, γ-aminopropylmethyldiethoxysilane, γ-aminopropylmethyldimethoxysilane, 4-aminobutyl methyl diethoxysilane, 11-aminoundecyl methyl diethoxysilane, m-aminophenyl methyl dimethoxysilane, p-aminophenyl methyl dimethoxysilane, 3-aminopropylmethylbis(methoxyethoxyethoxy)silane, 2-(4-pyridylethyl) methyldiethoxysilane, 2-(methyldimethoxysilylethyl) pyridine, N-(3-methyldimethoxysilylpropyl) pyrrole,

3-(m-aminophenoxy) propylmethyldimethoxysilane, N-(2-aminoethyl)-3-aminopropylmethyldimethoxysilane, N-(2-aminoethyl)-3-aminopropylmethyldiethoxysilane, N-(6-aminohexyl) aminomethylmethyldiethoxysilane, N-(6-aminohexyl) aminopropylmethyldimethoxysilane, N-(2-aminoethyl)-11-aminoundecylmethyldimethoxysilane, (aminoethylaminomethyl) phenethylmethyldimethoxysilane, N-3-[(amino(polypropyleneoxy))] aminopropylmethyldimethoxysilane, n-butyl aminopropylmethyldimethoxysilane, N-ethylaminoisobutylmethyldimethoxysilane, N-methylaminopropylmethyldimethoxysilane, N-phenyl-γ-aminopropylmethyldimethoxysilane, N-phenyl-γ-aminomethylmethyldiethoxysilane, (cyclohexylaminomethyl) methyl diethoxysilane, N-cyclohexylaminopropylmethyldimethoxysilane, bis(2-hydroxyethyl)-3 -aminopropylmethyldiethoxysilane, diethylaminomethylmethyldiethoxysilane, diethylaminopropylmethyldimethoxysilane, dimethylaminopropylmethyldimethoxysilane, N-3-methyldimethoxysilylpropyl-m-phenylenediamine, N,N-bis[3-(methyldimethoxysilyl) propyl] ethyl enediamine, bis(methyldiethoxysilylpropyl) amine, bis(methyldimethoxysilylpropyl) amine, bis[(3-methyldimethoxysilyl) propyl]-ethylenediamine, bis[3-(methyldiethoxysilyl) propyl] urea, bis(methyldimethoxysilylpropyl) urea, N-(3-methyldiethoxysilylpropyl)-4,5-dihydroimidazole, ureidopropylmethyldiethoxysilane, ureidopropylmethyldimethoxysilane, acetamidopropylmethyldimethoxysilane, 2-(2-pyridylethyl) thiopropylmethyldimethoxysilane, 2-(4-pyridylethyl) thiopropylmethyldimethoxysilane, bis[3-(methyldiethoxysilyl) propyl] disulfide, 3-(methyldiethoxysilyl) propyl succinic anhydride, γ-mercaptopropyl methyl dimethoxysilane, γ-mercaptopropyl methyl diethoxysilane, isocyanatopropyl methyl dimethoxysilane,

isocyanatopropylmethyldiethoxysilane, isocyanatoethylmethyldiethoxysilane, isocyanatomethylmethyldiethoxysilane, carboxyethylmethylsilanediol sodium salt, N-(methyldimethoxysilylpropyl) ethylenediamine triacetate trisodium salt, 3-(methyldihydroxysilyl)-1-propanesulfonic acid, diethylphosphate ethylmethyldiethoxysilane, 3-methyldihydroxysilyl propyl methylphosphonate sodium salt, bis(methyldiethoxysilyl) ethane, bis(methyldimethoxysilyl) ethane, bis(methyldiethoxysilyl) methane, 1,6-bis(methyldiethoxysilyl) hexane, 1,8-bis(methyldiethoxysilyl) octane, p-bis(methyldimethoxysilylethyl) benzene, p-bis(methyldimethoxysilylmethyl) benzene, 3-methoxypropylmethyldimethoxysilane, 2-[methoxy(polyethyleneoxy)propyl] methyldimethoxysilane, methoxytriethyleneoxypropylmethyldimethoxysilane, tris(3-methyldimethoxysilylpropyl) isocyanurate, [hydroxy (polyethyleneoxy) propyl] methyldiethoxysilane, N,N′-bis(hydroxyethyl)-N,N′ -bis(methyldimethoxysilylpropyl) ethylenediamine, bis-[3-(methyldiethoxysilylpropyl)-2-hydroxypropoxy] polyethylene oxide, bis[N,N′-(methyldiethoxysilylpropyl) aminocarbonyl] polyethylene oxide, and bis(methyldiethoxysilylpropyl) polyethylene oxide. Among these, particularly preferred examples can include dimethyldimethoxysilane, diethyldimethoxysilane, dimethyldiethoxysilane, diethyldiethoxysilane, and the like from the viewpoints of easy availability and adhesiveness to a hydrophilic layer.

Examples of trifunctional organoalkoxysilane can include methyltrimethoxysilane, ethyltrimethoxysilane, propyltrimethoxysilane, methyltriethoxysilane, ethyltriethoxysilane, propyltriethoxysilane, γ-chloropropyltriethoxysilane, γ-chloropropyltrimethoxysilane, chloromethyltriethoxysilane, (p-chloromethyl)phenyltrimethoxysilane, γ-bromopropyltrimethoxysilane, acetoxymethyltriethoxysilane, acetoxymethyltrimethoxysilane, acetoxypropyltrimethoxysilane, benzoyloxypropyltrimethoxysilane, 2-(carbomethoxy) ethyltrimethoxysilane, phenyltrimethoxysilane, phenyltriethoxysilane, phenyltripropoxysilane, hydroxymethyltriethoxysilane, N-(triethoxysilylpropyl)-O-polyethylene oxide urethane, N-(3-triethoxysilylpropyl)-4-hydroxybutyramide, N-(3-triethoxysilylpropyl) gluconamide, vinyl trimethoxysilane, vinyl triethoxysilane, vinyl tributoxysilane, isopropenyl trimethoxysilane, isopropenyl triethoxysilane, isopropenyl tributoxysilane, vinyltris(2-methoxyethoxy)silane, allyltrimethoxysilane, vinyldecyltrimethoxysilane, vinyloctyltrimethoxysilane, vinylphenyltrimethoxysilane, isopropenylphenyltrimethoxysilane, 2-(meth)acryloxyethyltrimethoxysilane, 2-(meth)acryloxyethyltriethoxysilane, 3-(meth)acryloxypropyltrimethoxysilane, 3-(meth)acryloxypropyltrimethoxysilane, 3-(meth)-acryloxypropyltris(2-methoxyethoxy)silane, 3-[2-(allyloxycarbonyl) phenylcarbonyloxy]propyltrimethoxysilane,

3-(vinylphenylamino)propyltrimethoxysilane, 3-(vinylphenylamino)propyltriethoxysilane, 3-(vinylbenzylamino)propyltriethoxysilane, 3-(vinylbenzylamino)propyltriethoxysilane, 3-[2-(N-vinylphenylmethylamino)ethylamino]propyltrimethoxysilane, 3-[2-(N-isopropenylphenylmethylamino)ethylamino]propyltrimethoxysilane, 2-(vinyloxy)ethyltrimethoxysilane, 3-(vinyloxy)propyltrimethoxysilane, 4-(vinyloxy)butyltriethoxysilane, 2-(isopropenyloxy)ethyltrimethoxysilane, 3-(allyloxy)propyltrimethoxysilane, 10-(allyloxycarbonyl)decyltrimethoxysilane, 3-(isopropenylmethyloxy) propyltrimethoxysilane, 10-(isopropenylmethyloxycarbonyl) decyltrimethoxysilane, 3-[(meth)acryloxypropyl]trimethoxysilane, 3-[(meth)acryloxypropyl]triethoxysilane, 3-[(meth)acryloxymethyl]trimethoxysilane, 3-[(meth)acryloxymethyl]triethoxysilane, γ-glycidoxypropyltrimethoxysilane, N-[3-(meth)acryloxy-2-hydroxypropyl]-3-aminopropyltriethoxysilane, O-“(meth)acryloxyethyl”-N-(triethoxysilylpropyl)urethane, γ-glycidoxypropyltriethoxysilane, β-(3,4-epoxycyclohexyl)ethyltrimethoxysilane, γ-aminopropyltriethoxysilane, γ-aminopropyltrimethoxysilane, 4-aminobutyltriethoxysilane, 11-aminoundecyltriethoxysilane, m-aminophenyltrimethoxysilane, p-aminophenyltrimethoxysilane, 3-aminopropyltris(methoxyethoxyethoxy)silane, 2-(4-pyridylethyl)triethoxysilane, 2-(trimethoxysilylethyl)pyridine,

N-(3-trimethoxysilylpropyl)pyrrole, 3-(m-aminophenoxy)propyltrimethoxysilane, N-(2-aminoethyl)-3-aminopropyltrimethoxysilane, N-(2-aminoethyl)-3-aminopropyltriethoxysilane, N-(6-aminohexyl)aminomethyltriethoxysilane, N-(6-aminohexyl)aminopropyltrimethoxysilane, N-(2-aminoethyl)-11-aminoundecyltrimethoxysilane, (aminoethylaminomethyl)phenethyltrimethoxysilane, N-3-[(amino(polypropyleneoxy))]aminopropyltrimethoxysilane, n-butylaminopropyltrimethoxysilane, N-ethylaminoisobutyltrimethoxysilane, N-methyl aminopropyltrimethoxysilane, N-phenyl-y-aminopropyltrimethoxysilane, N-phenyl-γ-aminomethyltriethoxysilane, (cyclohexylaminomethyl)triethoxysilane, N-cyclohexylaminopropyltrimethoxysilane, bis(2-hydroxyethyl)-3-aminopropyltriethoxysilane, diethylaminomethyltriethoxysilane, diethylaminopropyltrimethoxysilane, dimethylaminopropyltrimethoxysilane, N-3-trimethoxysilylpropyl-m-phenylenediamine, N,N-bis[3-(trimethoxysilyl)propyl]ethylenediamine, bis(triethoxysilylpropyl)amine, bis(trimethoxysilylpropyl)amine, bi s[(3-trimethoxysilyl)propyl]-ethylenediamine, bis[3-(triethoxysilyl)propyl]urea, bis(trimethoxysilylpropyl)urea, N-(3-triethoxysilylpropyl)-4,5-dihydroimidazole, ureidopropyltriethoxysilane, ureidopropyltrimethoxysilane, acetamidopropyltrimethoxysilane, 2-(2-pyridylethyl)thiopropyltrimethoxysilane, 2-(4-pyridylethyl)thiopropyltrimethoxysilane, bis[3-(triethoxysilyl)propyl]disulfide, 3-(triethoxysilyl)propylsuccinic anhydride, γ-mercaptopropyltrimethoxysilane, γ-mercaptopropyltriethoxysilane, isocyanatopropyltrimethoxysilane, isocyanatopropyltriethoxysilane, isocyanatoethyltriethoxysilane, isocyanatomethyltriethoxysilane, a sodium salt of carboxyethylsilanetriol, a trisodium salt of N-(trimethoxysilylpropyl)ethylenediamine triacetate, 3-(trihydroxysilyl)-1-propanesulfonic acid, diethyl phosphate ethyl triethoxysilane, a sodium salt of 3-trihydroxysilylpropyl methylphosphonate, bis(triethoxysilyl)ethane, bis(trimethoxysilyl)ethane, bis(triethoxysilyl)methane,

1,6-bis(triethoxysilyl)hexane, 1,8-bis(triethoxysilyl)octane, p-bis(trimethoxysilylethyl)benzene, p-bis(trimethoxysilylmethyl)benzene, 3-methoxypropyltrimethoxysilane, 2-[methoxy(polyethyleneoxy)propyl]trimethoxysilane, methoxytriethyleneoxypropyltrimethoxysilane, tris(3-trimethoxysilylpropyl)isocyanurate, [hydroxy(polyethyleneoxy)propyl]triethoxysilane, N,N′-bis(hydroxyethyl)-N,N′-bis(trimethoxysilylpropyl)ethylenediamine, bis-[3-(triethoxysilylpropyl)-2-hydroxypropoxy]polyethylene oxide, bis [N,N′-(triethoxysilylpropyl)aminocarbonyl]polyethylene oxide, and bis(triethoxysilylpropyl)polyethylene oxide.

Among these, particularly preferred examples can include methyltrimethoxysilane, ethyltrimethoxysilane, methyltriethoxysilane, ethyltriethoxysilane, 3-glycidoxy propyl trimethoxysilane, and the like from the viewpoints of easy availability and adhesiveness to a hydrophilic layer.

Examples of bifunctional organoalkoxy titanate can include dimethyl dimethoxy titanate, diethyl dimethoxy titanate, propyl methyl dimethoxy titanate, dimethyl diethoxy titanate, diethyl diethoxy titanate, dipropyl diethoxy titanate, phenylethyl diethoxy titanate, phenyl methyl dipropoxy titanate, dimethyl dipropoxy titanate, and the like.

Examples of trifunctional organoalkoxy titanate can include methyl trimethoxy titanate, ethyl trimethoxy titanate, propyl trimethoxy titanate, methyl triethoxy titanate, ethyl triethoxy titanate, propyl triethoxy titanate, chloromethyl triethoxy titanate, phenyl trimethoxy titanate, phenyltriethoxy titanate, phenyltripropoxy titanate, and the like.

Examples of bifunctional and trifunctional organoalkoxy zirconates can include organoalkoxy zirconate obtained by replacing Ti with Zr in a compound exemplified as bifunctional and trifunctional organoalkoxy titanates.

Examples of bifunctional and trifunctional organoalkoxy aluminates can include organoalkoxy aluminate obtained by replacing Ti with Al in a compound exemplified as bifunctional and trifunctional organoalkoxy titanates.

In a case of obtaining a sol-gel cured product, it is preferable to use a combination of a tetrafunctional alkoxide compound and at least one alkoxide compound selected from bifunctional and trifunctional alkoxide compounds.

In a case of the above combination use, a ratio of the tetrafunctional alkoxide compound to the at least one alkoxide compound selected from bifunctional and trifunctional alkoxide compounds is preferably from 0.01 to 100, more preferably from 0.02 to 80, particularly preferably from 0.05 to 50, and particularly preferably from 0.1 to 40, in terms of a mass ratio of the former alkoxide compound to the latter alkoxide compound.

These tetraalkoxide compounds and organoalkoxide compounds are easily available as commercial products, and can also be obtained by a known synthesis method such as a reaction between each metal halide and an alcohol.

For the tetraalkoxide compound and the organoalkoxide compound, one compound may be used alone, or two or more kinds of the compounds may be used in combination.

Particularly preferred examples of the tetraalkoxide compound include tetramethoxysilane, tetraethoxysilane, tetrapropoxy titanate, tetraisopropoxy titanate, tetraethoxy zirconate, tetrapropoxy zirconate, and the like. In addition, particularly preferred examples of the organoalkoxide compound include methyltrimethoxysilane, dimethyldiethoxysilane, 3-glycidoxypropyltrimethoxysilane, 2-(3,4-epoxycyclohexyl)ethyltrimethoxysilane, ureidopropyltriethoxysilane, diethyl dimethoxysilane, propyl triethoxy titanate, ethyl triethoxy zirconate, and the like.

The heat insulation paint according to the embodiment of the present invention may contain a metal coupling agent having a functional group capable of interacting with the fibrous conductive particles. For example, in a case where the fibrous conductive particles are silver nanowires, preferred specific examples of the functional group capable of interacting with the fibrous conductive particles include a mercapto group, an amino group, an amide group, a carboxylic acid group, a sulfonic acid group, a phosphoric acid group, a phosphonic acid group, and the like. As the metal coupling agent having a functional group capable of interacting with the silver nanowires, a compound having the above functional group may be selected from the specific examples exemplified as the above-described bifunctional or trifunctional metal alkoxide compound.

The heat insulation paint according to the embodiment of the present invention preferably satisfies at least one of the following conditions (i) or (ii), more preferably satisfies at least the following condition (ii), and particularly preferably satisfies the following conditions (i) and (ii).

(i) A ratio of an amount of at least one substance which is selected from silicon, zirconium, titanium oxide, or aluminum, is derived from an inorganic oxide binder, and is contained in the heat insulation paint, to a substance amount of a metal element (a) derived from the fibrous conductive particles, [(mol number of element (b))/mol number of metal element (a))] is within the range of 0.10/1 to 22/1.

(ii) A ratio of a mass of the alkoxide compound used for forming the sol-gel cured product in the heat insulation paint, to a mass of the metal nanowires, [(content of alkoxide compound/content of metal nanowires)] is within the range of 0.25/1 to 30/1.

Examples of the binder contained in the heat insulation paint of the present invention include at least one organic polymer binder selected from the group consisting of polycycloolefin and polyacrylonitrile, in addition to the above-described inorganic oxide binder selected from the group consisting of silicon oxide, zirconium oxide, titanium oxide, and aluminum oxide.

In a case where at least one organic polymer binder selected from the group consisting of polycycloolefin and polyacrylonitrile is contained as the specific binder contained in the heat insulation paint of the present invention, in a case where the content of the at least one organic polymer binder selected from the group consisting of polycycloolefin and polyacrylonitrile exceeds 50% by mass with respect to the total amount of the binder contained in the heat insulation paint, it is preferable because a heat insulation layer having particularly excellent heat insulation property and radio wave permeability can be obtained.

The polycycloolefin and the polyacrylonitrile as the specific binders contained in the heat insulation paint according to the embodiment of the present invention will be described below.

The “polycycloolefin” refers to a polymer or copolymer obtained by using an alicyclic compound having a double bond. A basic structure of the polycycloolefin layer is composed of carbon atoms and hydrogen atoms, and thus stretching vibration of a C-H group occurs on a short wavelength side (mid infrared region) of infrared rays, and the absorption in a far infrared region is small. Therefore, an average transmittance for far infrared rays having a wavelength of 5 μm to 10 μm in terms of an average transmittance with a film thickness of 2 μm can be made to be 50% or more.

As the polycycloolefin, a material of a transparent films described in paragraphs [0020] to [0022] and examples of JP2012-189683A can be preferably used. Specifically, the polycycloolefin used as a main component of the binder of the heat insulation paint is preferably polynorbornene. The polynorbornene has less absorption in the infrared region and has excellent heat insulation property and weather fastness. As the polynorbornene, a commercially available polynorbornene (for example, ZEONEX or ZEONOR manufactured by Zeon Corporation) may be used.

As the polyacrylonitrile, a homopolymer of polyacrylonitrile may be used, and a copolymer of polyacrylonitrile and other repeating units may be used as long as the gist of the present invention is not violated.

As the polyacrylonitrile, a material of a protective layer described in paragraphs 0020 to 0041 and examples of JP2013-144427A can be preferably used.

As the polyacrylonitrile, commercially available polyacrylonitrile may be used. For example, a fully hydrogenated nitrile rubber (trade name THERBAN 5005 and THERBAN 3047, both manufactured by LANXESS), a hydrogenated nitrile rubber (trade name THERBAN 5065, THERBAN 4367, and 3496, all manufactured by LANXESS), and an acrylonitrile butadiene rubber (trade name N22L, manufactured by JSR Corporation) may also be used.

In a case where the content of the binder contained in the heat insulation paint is from 50% by mass to 98% by mass with respect to the total solid content of the heat insulation paint, a heat insulation layer having excellent heat insulation property and radio wave permeability can be obtained, which is preferable.

[Matrix Other Than Material]

The material that is contained in the heat insulation paint and that exhibits an average transmittance of 50% or more for far infrared rays having a wavelength of 5 μm to 10 μm in terms of an average transmittance with a film thickness of 2 μm has a function as a matrix. The heat insulation paint may further contain a matrix (hereinafter referred to as “another matrix”) other than the material that exhibits an average transmittance of 50% or more for far infrared rays having a wavelength of 5 μm to 10 μm in terms of an average transmittance with a film thickness of 2 μm.

Another matrix may be a non-photosensitive matrix such as an organic macromolecular polymer or a photosensitive matrix such as a photoresist composition.

In a case where the heat insulation paint contains another matrix, it is advantageous that the content thereof is 0.10% by mass to 20% by mass with respect to the content of a material that is contained in the heat insulation paint and that exhibits a maximum peak value of reflectivity of 20% or more for far infrared rays having a wavelength of 5 to 25 μm, or a material that is contained in the heat insulation paint and that exhibits an average transmittance of 50% or more for far infrared rays having a wavelength of 5 μm to 10 μm in terms of an average transmittance with a film thickness of 2 μm; this is because a heat insulation layer having excellent heat insulation property, transparency, film hardness, abrasion resistance, and bend-tolerance can be obtained. From the same viewpoint, the content of another matrix is preferably 0.15% by mass to 10% by mass, and more preferably 0.20% by mass to 5% by mass, with respect to the content of the material that is contained in the heat insulation paint and that exhibits a maximum peak value of reflectivity of 20% or more for far infrared rays having a wavelength of 5 to 25 μm, or the material that is contained in the heat insulation paint and that exhibits an average transmittance of 50% or more for far infrared rays having a wavelength of 5 μm to 10 μm in terms of an average transmittance with a film thickness of 2 μm.

[Dispersant]

A dispersant is used for dispersion while preventing the above-described aggregation of the fibrous conductive particles in a photopolymerizable composition. The dispersant is not particularly limited as long as metal nanowires can be dispersed thereby, and can be appropriately selected depending on the purpose. For example, a commercially available dispersant can be used as a pigment dispersant, and in particular, a polymer dispersant having a property of adsorbing to metal nanowires is preferable. Examples of such polymer dispersants include polyvinyl pyrrolidone, BYK series (registered trademark, manufactured by BYK Additives & Instruments), SOLSPERSE series (registered trademark, manufactured by Japan Lubrizol Corporation and the like), AJISPER series (registered trademark, manufactured by AJINOMOTO CO., INC.), and the like.

In a case of using the binder described in paragraphs [0086] to [0095] of JP2013-225461A, the content of the dispersant in the heat insulation paint is preferably from 0.1 parts by mass to 50 parts by mass, more preferably from 0.5 parts by mass to 40 parts by mass, and particularly preferably from 1 part by mass to 30 parts by mass with respect to 100 parts by mass of the binder.

In a case where the content of the dispersant is 0.1 parts by mass or more with respect to 100 parts by mass of the binder, the aggregation of the fibrous conductive particles in a dispersion is effectively suppressed, and in a case where the content of the dispersant is 50 parts by mass or less, a stable liquid film is formed in a coating step, and thus occurrence of coating unevenness is suppressed, which is preferable.

[Solvent]

A solvent is a component used for forming a coating solution from a composition that contains the above-described fibrous conductive particles and a binder, the coating solution being used for forming a film on a surface of a support or a surface of an adhesive layer of a support provided with the adhesive layer, and the binder including, as a main component, a material that exhibits a maximum peak value of reflectivity of 20% or more for far infrared rays having a wavelength of 5 to 25 μm, or a material that exhibits an average transmittance of 50% or more for far infrared rays having a wavelength of 5 μm to 10 μm in terms of an average transmittance with a film thickness of 2 μm. The solvent can be appropriately selected depending on the purpose. The solvent may be any solvent so long as the solvent can dissolve the binder in an amount of 0.1% by mass or more, and examples thereof include water, an alcohol-based solvent, a ketone-based solvent, an ether-based solvent, a hydrocarbon-based solvent, an aromatic solvent, a halogen solvent, and the like. At least some of the solvent of the metal nanowire dispersion may also be used this solvent. For these solvents, one may be used alone, or two or more kinds thereof may be used in combination.

A solid content concentration of the coating solution containing such a solvent is preferably within a range of 0.1% by mass to 20% by mass.

[Metal Corrosion Inhibitor]

In a case where the heat insulation paint, and the heat insulation layer produced from the heat insulation paint contain fibrous metal particles such as metal nanowires as the fibrous conductive particles, it is preferable that the heat insulation paint and the heat insulation layer contain a metal corrosion inhibitor. Such a metal corrosion inhibitor is not particularly limited and can be appropriately selected according to the purpose, but for example, thiols, azoles, and the like are suitable.

By containing the metal corrosion inhibitor, an anti-corrosive effect can be exhibited, and a deterioration of the heat insulation property and the transparency of the heat insulation layer due to the passage of time can be suppressed. The metal corrosion inhibitor can be added, to the heat insulation paint, in a state of being dissolved in a suitable solvent state of a powder, or can be applied after producing a conductive film by a coating solution for a conductive layer described later by allowing the film to be immersed in the metal corrosion inhibitor.

In a case where the metal corrosion inhibitor is added, a content of the metal corrosion inhibitor in the heat insulation paint is preferably 0.5% by mass to 10% by mass with respect to the content of the fibrous conductive particles.

As another matrix, it is possible to use the polymer compound which is the dispersant used in the production of the fibrous conductive particles, as at least a part of the components constituting the matrix.

[Other Conductive Materials]

In addition to the fibrous conductive particles, other conductive materials, for example, conductive particles and the like can be used in the heat insulation paint as long as the effects of the present invention is not impaired. Examples of the conductive particles include conductive oxide particles such as metal particles, tin-doped indium oxide (ITO) particles, antimony-doped tin oxide (ATO) particles, cesium-doped tungsten oxide (CWO) particles, and the like. In particular, ITO is preferable because ITO increases infrared reflection of the heat insulation layer. From the viewpoint of the effect, a content ratio of the fibrous conductive particles (preferably the metal nanowires having an aspect ratio of 10 or more) is preferably 50% or more, more preferably 60% or more, and particularly preferably 75% or more on a volume basis with respect to the total amount of the conductive materials containing the fibrous conductive particles. When the content ratio of the fibrous conductive particles is 50%, it is possible to easily obtain a heat insulation layer having a high level of heat insulation property. An upper limit value of the content ratio of the fibrous conductive particles with respect to the total amount of the conductive material containing the fibrous conductive particles is not particularly limited, and may be 100% or 90%, for example.

In addition, the conductive particles having a shape other than the fibrous conductive particles do not greatly contribute to conductivity of the heat insulation layer and may have absorption in a visible light region in some cases. In particular, from the viewpoint of preventing the transparency of the heat insulation layer from deteriorating, it is preferable that the conductive particle is a metal and does not have a shape in which plasmon absorption is strong, such as a spherical shape.

A ratio of the fibrous conductive particles can be obtained as follows. For example, in a case where the fibrous conductive particles are silver nanowires and the conductive particles are silver particles, a silver nanowire aqueous dispersion liquid is filtered so as to separate the silver nanowires from other conductive materials. An amount of silver remaining in a filter paper and an amount of silver that has passed through the filter paper are measured by using an inductively coupled plasma (ICP) emission spectrometer, and therefore a ratio of the metal nanowires can be calculated. The aspect ratio of the fibrous conductive particles can be calculated by observing the fibrous conductive particles remaining in the filter paper with TEM, and measuring the short axis length and the long axis length of 300 fibrous conductive particles, respectively.

The method for measuring the average short axis length and average long axis length of the fibrous conductive particles is as described above.

[Other Additives]

The heat insulation paint may contain a surfactant as another additive.

As the surfactant, a known surfactant such as an anionic surfactant and a nonionic surfactant can be used.

Even if the heat insulation paint of the present invention is applied to a surface of an object to be coated and then dried, the paint can impart the heat insulation function to the object to be coated by forming the heat insulation layer having a desired thickness.

[Organic Solvent]

The heat insulation paint may contain an organic solvent as another additive. By containing the organic solvent, a more homogeneous liquid film can be formed on the object to be coated.

Examples of the organic solvent include a ketone-based solvent such as acetone, methyl ethyl ketone, and diethyl ketone, an alcohol-based solvent such as methanol, ethanol, 2-propanol, 1-propanol, 1-butanol, and tert-butanol, a chlorinated solvent such as chloroform and methylene chloride, and an aromatic solvent such as benzene and toluene, an ester-based solvent such as ethyl acetate, butyl acetate, and isopropyl acetate, an ether-based solvent such as diethyl ether, tetrahydrofuran, and dioxane, a glycol ether-based solvent such as ethylene glycol monomethyl ether and ethylene glycol dimethyl ether, and the like.

In a case where the heat insulation paint contains the organic solvent, the content thereof is preferably within a range of 50% by mass or less, and more preferably within a range of 30% by mass or less with respect to the total mass of the composition.

It is preferable that the heat insulation paint according to the embodiment of the present invention would exhibit a surface electrical resistance of 1000Ω/square or more when the heat insulation paint is formed into a coated film having a film thickness of 500 nm since such a configuration enables a heat insulation layer having excellent heat insulation property and radio wave permeability to be obtained. Furthermore, in a case where the surface electrical resistance is 1500Ω/square or more, the heat insulation layer having further excellent heat insulation property and radio wave permeability can be obtained, and in a case where the surface electrical resistance is 3000Ω/square or more, the heat insulation layer having still further excellent heat insulation property and radio wave permeability can be obtained. An upper limit value of the surface electrical resistance is not particularly limited, and may be 1017Ω/square, 1016Ω/square, or 1015Ω/square, for example.

Furthermore, in the heat insulation paint of the present invention, a ratio of an average secondary particle diameter a of the fibrous conductive particles before dilution to an average secondary particle diameter b of the fibrous conductive particles when diluted 10-fold, is preferably from 0.8 to 1.2 with respect to the ratio of the average secondary particle diameter a to the average secondary particle diameter b. The heat insulation paint in which the above ratio is from 0.8 to 1.2 has excellent dispersion stability in a case of being stored for a long period of time. The ratio of the average secondary particle diameter a to the average secondary particle diameter b is more preferably from 0.85 to 1.15, and still more preferably from 0.9 to 1.1.

The average secondary particle diameter is a value measured using concentrated-system particle size analyzer FPER-1000 (manufactured by OTSUKA ELECTRONICS Co., Ltd.).

The heat insulation paint according to the embodiment of the present invention can be applied to, for example, a roll-up curtain fabric so as to obtain a heat insulation roll-up curtain.

In addition, in a case where the heat insulation paint according to the embodiment of the present invention is applied to a window glass of buildings, window glass of automobiles and railroad vehicles, or window materials of aircraft, it is possible to obtain a window having heat insulation property.

In addition, in a case where the heat insulation paint according to the embodiment of the present invention is applied to an outer side of a cup, a heat retention cup can be obtained.

The heat insulation roll-up curtain, the heat insulation window glass, and the heat retention cup produced by using the heat insulation paint of the present invention have not only excellent heat insulation property but also have radio wave permeability.

Accordingly, for example, the case of the heat insulation roll-up curtain, the heat insulation window glass, and the like, hardly causes a problem in speech quality on the mobile phones. In addition, in the case of the heat retention cup, the cup can be used for warming in a microwave oven.

The object to be coated on which the heat insulation paint of the present invention is applied is preferably a transparent substrate.

[Transparent Substrate]

The transparent substrate may be appropriately selected depending on the application, but in general, a plate-like substrate is suitably used.

Examples of the transparent substrate include transparent glass such as white plate glass, blue plate glass, and silica coated blue plate glass; synthetic resins such as polycarbonate, polyether sulfone, polyester, acrylic resin, vinyl chloride resin, aromatic polyamide resin, polyamide imide, and polyimide; metals such as aluminum, copper, nickel, and stainless steel; ceramics, silicon wafers used for semiconductor substrates, and the like. Among these, the transparent substrate is preferably the substrate of the glass or the resin, and more preferably the glass substrate. A glass component is not particularly limited, and for example, transparent glass such as white plate glass, blue plate glass, and silica coated blue plate glass is suitable.

It is preferable that the transparent substrate has a smooth surface, and float glass is particularly preferable.

In order to form the heat insulation layer using the heat insulation paint according to the embodiment of the present invention, it is preferable to perform applying the heat insulation paint on a desired object to be coated so as to form a coated film, and allowing a reaction of hydrolysis and polycondensation of the alkoxide compound in this coated film (hereinafter this reaction of hydrolysis and polycondensation is also referred to as “sol-gel reaction”) to occur so as to form the heat insulation layer. This method may or may not further include evaporation (drying) by heating of water which may be contained as a solvent in the heat insulation paint, if necessary.

The heat insulation paint may be prepared by preparing an aqueous dispersion of metal nanowires and mixing the dispersion with an alkoxide compound. A sol gel coating solution may be prepared by preparing an aqueous solution containing an alkoxide compound, heating the aqueous solution to hydrolyze and polycondensate at least some of the alkoxide compound so as to be in a sol state, mixing the aqueous solution in the sol state with the aqueous dispersion of the metal nanowires.

In a case where an acidic catalyst or a basic catalyst is used in combination in order to promote the sol-gel reaction, the reaction efficiency can be enhanced, which is preferable in practical use.

The method for applying the heat insulation paint is not particularly limited. The application of the heat insulation paint can be carried out by a general coating method, and the method thereof can be appropriately selected according to the purpose. Examples of the coating method include a roll coating method, a bar coating method, a dip coating method, a spin coating method, a casting method, a die coating method, a blade coating method, a gravure coating method, a curtain coating method, a spray coating method, a doctor coating method, and the like.

A reaction of hydrolysis and condensation of the alkoxide compound occurs in the coated film of the sol gel coating solution formed on the object to be coated, but in order to accelerate the reaction, it is preferable to heat and dry the coated film. The heating temperature for accelerating the sol-gel reaction is preferably a temperature within a range of 30° C. to 200° C., and is more preferably a temperature within the range of 50° C. to 180° C. The heating and drying time is preferably from 10 seconds to 300 minutes, and more preferably from 1 minute to 120 minutes.

### EXAMPLES

Hereinafter, the present invention will be described more specifically with reference to examples, but the present invention is not limited to the following examples the examples are beyond their gist. In addition, unless otherwise specified, “parts” and “%” are on a mass basis.

### Example 1

<Preparation of Silver Nanowire Aqueous Dispersion (1)>

The following additive solutions A, G and H were previously prepared.

(Additive Solution A)

5.1 g of silver nitrate powder was dissolved in 500 milliliter (mL) of pure water. Thereafter, 1 normal (1 mol/liter) of aqueous ammonia was added thereto until the solution became transparent. After that, pure water was added so that the total amount becomes 1000 mL.

(Additive Solution G)

The additive solution G was prepared by dissolving 1 g of glucose powder in 280 mL of pure water.

(Additive Solution H)

The additive solution H was prepared by dissolving 4 g of hexadecyl-trimethylammonium bromide (HTAB) powder in 220 mL of pure water.

Next, a silver nanowire aqueous dispersion (1) was prepared as follows.

410 mL of pure water was put into a three-neck flask, and while stirring at 20° C., 82.5 mL of the additive solution H and 206 mL of the additive solution G were added through a funnel. To the solution, 206 mL of the additive solution A was added at a flow rate of 2.0 mL/min and a stirring rotation speed of 800 revolutions per minute (rpm). After 10 minutes elapsed thereafter, 82.5 mL of the additive solution H was added. Thereafter, an internal temperature was raised to 73° C. at 3° C./min, and then the stirring rotation speed was dropped to 200 rpm, followed by heating for 2 hours. The obtained aqueous dispersion was cooled.

Ultrafiltration module SIP1013 (product name, manufactured by Asahi Kasei Corporation, fraction molecular weight: 6000), a magnetic pump, and a stainless-steel cup were connected by a silicone tube so as to prepare an ultrafiltration device.

The above-described aqueous dispersion after cooling was put into the stainless-steel cup of the ultrafiltration device, and the pump was driven to perform ultrafiltration. At the point where the filtrate from the ultrafiltration module reached 50 mL, 950 mL of distilled water was added to the stainless-steel cup, and silver nanowires were washed. The above-described washing was repeated until electric conductivity (measured with CM-25R manufactured by DKK-TOA CORPORATION) reached 50 μS/cm or less, followed by concentration, and therefore 0.84% silver nanowire aqueous dispersion (1) was obtained. An average short axis length, an average long axis length, and a coefficient of variation of a short axis length of the silver nanowires contained in the obtained silver nanowire aqueous dispersion (1) was measured by the following method. As a result, it was found that the silver nanowires having an average short axis length of 17.0 nm, an average long axis length 10 μm, and a coefficient of variation of 18% were obtained.

<Average Short Axis Length (Average Diameter) and Average Long Axis Length of Metal Nanowires>

With respect to 300 metal nanowires randomly selected from the silver nanowires which were magnified and observed by using a transmission electron microscope (TEM; manufactured by JEOL Ltd., product name: JEM-2000FX), a short axis length (diameter) and a long axis length of the metal nanowires were measured. From these average values, an average short axis length (average diameter) and an average long axis length of the metal nanowires were obtained.

<Coefficient of Variation of Short Axis Length (Diameter) of Metal Nanowires>

The short axis length (diameter) of the 300 nanowires randomly selected from the above image of the transmission electron microscope (TEM) was measured, and standard deviation and an average value of the 300 nanowires were calculated so as to obtained values thereof. The coefficient of variation was obtained by dividing the standard deviation value by the average value.

<Production of Heat Insulation Paint 1>

A solution of an alkoxide compound having the following composition was stirred at 60° C. for 1 hour, it was confirmed that a homogeneous solution was obtained so as to prepare a sol-gel solution. 8.1 parts of the obtained sol-gel solution and 32.70 parts of the silver nanowire aqueous dispersion (1) were mixed and further diluted with 9.2 parts of distilled water. Therefore, a heat insulation paint 1 of Example 1 in which the content of the silver nanowires was 14% with respect to the total solid content was obtained.

(Solution of Alkoxide Compound)

Tetraethoxysilane (trade name: KBE-04, manufactured by Shin-Etsu Chemical Co., Ltd.) 5.0 parts

3-mercaptopropylmethyldimethoxysilane (metal coupling agent having a functional group capable of interacting with the silver nanowires, trade name: KBM-802, manufactured by Shin-Etsu Chemical Co., Ltd.) 0.04 parts

1% acetic acid aqueous solution 10.0 parts

Distilled water 4.0 parts

### Example 2

A heat insulation paint 2 of Example 2 was produced in the same manner as in Example 1 except that the mixing ratio of the sol-gel solution and the silver nanowire aqueous dispersion (1) was changed so that the amount of the fibrous conductive particles becomes 27% with respect to the total solid content.

### Example 3

A heat insulation paint 3 of Example 3 was produced in the same manner as in Example 1 except that the mixing ratio of the sol-gel solution and the silver nanowire aqueous dispersion (1) was changed so that the amount of the fibrous conductive particles becomes 20% with respect to the total solid content.

### Example 4

A heat insulation paint 4 of Example 4 was produced in the same manner as in Example 1 except that the mixing ratio of the sol-gel solution and the silver nanowire aqueous dispersion (1) was changed so that the amount of the fibrous conductive particles becomes 5% with respect to the total solid content.

### Example 5

A heat insulation paint 5 of Example 5 was produced in the same manner as in Example 1 except that instead of the silver nanowire aqueous dispersion (1), the silver nanowire aqueous dispersion (2) was used, which was obtained by heating at 73° C. for 1 hour instead of heating at 73° C. for 2 hours in the preparation of the silver nanowire aqueous dispersion (1).

An average long axis length of the silver nanowires contained in the silver nanowire aqueous dispersion (2) was measured in the same manner as in the case of the silver nanowire aqueous dispersion (1). As a result, it was found that the average long axis length was 4.8 μm.

### Example 6

A heat insulation paint 6 of Example 6 was produced in the same manner as in Example 1 except that instead of the silver nanowire aqueous dispersion (1), the silver nanowire aqueous dispersion (3) was used, which was obtained by heating at 73° C. for 4 hours instead of heating at 73° C. for 2 hours in the preparation of the silver nanowire aqueous dispersion (1).

An average long axis length of the silver nanowires contained in the silver nanowire aqueous dispersion (3) was measured in the same manner as in the case of the silver nanowire aqueous dispersion (1). As a result, it was found that the average long axis length was 25 μm.

### Example 7

A heat insulation paint 7 of Example 7 was produced in the same manner as in Example 6 except that instead of the silver nanowire aqueous dispersion (3), the silver nanowire aqueous dispersion (4) was used, which was obtained by adding the additive solution A (206 mL), the additive solution G (206 mL), and the additive solution H (82.5 mL) after heating at 73° C. for 4 hours in the preparation of the silver nanowire aqueous dispersion (3).

An average long axis length of the silver nanowires contained in the silver nanowire aqueous dispersion (4) was measured in the same manner as in the case of the silver nanowire aqueous dispersion (1). As a result, it was found that the average long axis length was 55 μm.

### Example 8

<Preparation of Solvent-Substituted Silver Nanowire Dispersion A>

After solvent substitution of the silver nanowire aqueous dispersion (1) obtained in Example 1 with n-propanol, solvent substitution with 1-isopropyl-4-methylcyclohexanone was further performed, and therefore a solvent-substituted silver nanowire dispersion A was prepared.

<Preparation of COP Solution>

A COP solution having the following composition was prepared.

Cycloolefin polymer (trade name, ZEONEX 480R, manufactured by ZEON CORPORATION) 1.0 part

1-Isopropyl-4-methylcyclohexane 15.0 parts

<Preparation of Heat insulation paint>

34.0 parts of the prepared COP solution and 32.70 parts of the silver nanowire dispersion subjected to the solvent substitution were mixed to prepare a heat insulation paint 8 of Example 8.

### Example 9

An acrylonitrile polymer (PAN) solution having the following composition was prepared.

Fully hydrogenated nitrile rubber (trade name, THERBAN 5005, manufactured by LANXESS) 1.0 part

Methyl ethyl ketone 15.0 parts

A heat insulation paint 9 of Example 9 was prepared in the same manner as in Example 8 except that the COP solution was changed to the same amount of the PAN solution.

### Example 10

A heat insulation paint 10 of Example 10 was prepared in the same manner as in Example 1 except that the mixing ratio of the sol-gel solution and the silver nanowire aqueous dispersion (1) was changed so that the amount of the fibrous conductive particles becomes 2% with respect to the total solid content (sol-gel solution:silver nanowire aqueous dispersion (1) =56.7:32.7).

### Example 11

A heat insulation paint 11 of Example 11 was prepared in the same manner as in Example 1 except that the mixing ratio of the sol-gel solution and the silver nanowire aqueous dispersion (1) was changed so that the amount of the fibrous conductive particles becomes 30% with respect to the total solid content.

### Example 12

A heat insulation paint 12 of Example 12 was prepared in the same manner as in Example 1 except that 1.0 part of 3-glycidoxypropyltrimethoxysilane and 4.0 parts of tetraethoxysilane were added instead of 5.0 parts of tetraethoxysilane to the heat insulation paint 1.

### Example 13

A heat insulation paint 13 of Example 13 was prepared in the same manner as in Example 1 except that 3-mercaptopropylmethyldimethoxysilane was not added, which is a metal coupling agent having a functional group capable of interacting with the silver nanowires in the heat insulation paint 1.

### Example 14

A heat insulation paint 14 of Example 14 was prepared in the same manner as in Example 13 except that 5 parts of tetrapropoxy titanate was added instead of 5 parts of tetraethoxysilane in the heat insulation paint 13.

### Example 15

A heat insulation paint 15 of Example 15 was prepared in the same manner as in Example 13 except that 5 parts of tetraethoxy zirconate was added instead of 5 parts of tetraethoxysilane in the heat insulation paint 13.

### Comparative Example 1

A heat insulation paint Cl of Comparative Example 1 was prepared in the same manner as in Example 1 except that the mixing ratio of the sol-gel solution and the silver nanowire aqueous dispersion (1) was changed so that the amount of fibrous conductive particles becomes 40% with respect to the total solid content.

### Comparative Example 2

A heat insulation paint C2 of Comparative Example 2 was prepared in the same manner as in Example 1 except that the mixing ratio of the sol-gel solution and the silver nanowire aqueous dispersion (1) was changed so that the amount of fibrous conductive particles becomes 1% with respect to the total solid content.

### Comparative Example 3

<Preparation of PVA Solution>

A PVA solution having the following composition was prepared.

Polyvinyl alcohol polymer (manufactured by Wako Pure Chemical Industries, Ltd.) 1.0 part

Distilled water 15.0 parts

<Preparation of Heat Insulation Paint>

A heat insulation paint C3 of Comparative Example 3 was prepared in the same manner as in Example 1 except that instead of mixing 8.1 parts of the sol-gel solution and 32.70 parts of the silver nanowire aqueous dispersion (1), 34.0 parts of the above-prepared PVA solution and 32.70 parts of the silver nanowire aqueous dispersion (1) were mixed.

### Comparative Example 4

A heat insulation paint C4 of Comparative Example 4 was prepared in the same manner as in Example 1 except that 32.7 parts of hollow silica particles (THRYLYA (registered trademark) 4110 (average particle diameter: 60 nm, manufactured by JGC C&C)) was used instead of the silver nanowire aqueous dispersion (1).

### Comparative Example 5

A polymethyl methacrylate (PMMA) solution having the following composition was prepared.

PMMA resin (trade name, DIANAL BR88, manufactured by MITSUBISHI RAYON CO., LTD.) 1.0 part

Methyl ethyl ketone 15.0 parts

A heat insulation paint C5 of Comparative Example 5 was prepared in the same manner as in Example 8 except that the COP solution was changed to the PMMA solution.

### Comparative Example 6

A heat insulation paint C6 of Comparative Example 6 was prepared in the same manner as in Example 1 except that 2.5 parts of 3-glycidoxypropyltrimethoxysilane and 2.5 parts of tetraethoxysilane were added instead of adding 5.0 parts of tetraethoxysilane to the heat insulation paint 1.

[Explanation of Measurement Method and Evaluation Method]

<Measurement of Amount of Fibrous Conductive Particles with respect to Total Solid Content>

Each heat insulation paint was dried and a mass thereof was measured to obtain the total solid content. Silver was eluted by adding concentrated nitric acid to the dried heat insulation paint, and an eluted amount of the silver in the solution was quantitively determined with ICPE-9800 (manufactured by Shimadzu Corporation), and a mass of the fibrous conductive particles was obtained.

An amount (unit: mass %) of the fibrous conductive particles with respect to the total solid content of each heat insulation paint is shown in Table 1 below.

<Measurement of Secondary Particle Size>

An average secondary particle diameter a of the fibrous conductive particles contained in each heat insulation paint was measured with concentrated-system particle size analyzer FPER-1000 (manufactured by OTSUKA ELECTRONICS Co., Ltd.).

Furthermore, an average secondary particle diameter b of the fibrous conductive particles contained in the diluted heat insulation paint obtained by diluting each heat insulation paint by 10-fold by a volumetric basis with the same solvent as the solvent contained in each heat insulation paint, was measured.

A ratio of the average secondary particle diameter a to the obtained average secondary particle diameter b is shown in the column of “ratio of secondary particle diameter before and after dilution” in Table 1 described later.

<Resistivity>

Using a noncontact resistance meter (EC-80, manufactured by NAPSON), resistivity of a coated film coated with the heat insulation paint such that a film thickness becomes 500 nm, was measured and the result thereof is shown in Table 1 described below.

The resistivity “OV” in Table 1 means an overrange, which indicates a high resistance (3000Ω/square or higher) that cannot be measured by the device.

<Average transmittance of Binder for Far Infrared Rays and Average transmittance in terms of Film Thickness>

Each binder material contained in the heat insulation paint was coated on a peeling film such that each film thickness thereof becomes from 5 μm to 50 μm, and dried and peeled from the peeling film, and therefore a self-supporting film made of the binder was obtained. The self-supporting film was cut into 2 cm square to prepare a sample for measuring a transmission spectrum.

A transmission spectrum of the sample for measuring a transmission spectrum within a wavelength range of 5 μm to 10 μm was measured using an infrared spectrometer (IFS 66v/S, manufactured by Bruker Optics).

An average transmittance in terms of the film thickness was calculated by measuring the transmission spectrum within a wavelength range of from 5 μm to 10 μm by a wavelength of 100 nm, measuring a film thickness of the binder material used or each protective layer material, and converting the transmittance at each wavelength by using Formula (1), and therefore the spectrum of the transmittance in terms of the film thickness at each wavelength was created. Furthermore, an arithmetic mean value of the transmittance in terms of the film thickness at each wavelength of the obtained spectrum, was set as an average transmittance of each binder material used or each protective layer material for far infrared rays having a wavelength of from 5μm to 10 μm in terms of an average transmittance with a film thickness of 2 μm.

T′=T^{(2/x)} Formula (1)

(T′ represents the transmittance in terms of the film thickness at each wavelength, T represents the transmittance at each wavelength, and x represents the average film thickness (unit: μm) of the sample for measurement.)

The results are shown in Table 1 described below.

<Viscosity>

Viscosity (unit: mPa·s) of the heat insulation paint was measured with a viscometer: TVB10 manufactured by TOKI SANGYO CO., LTD. The viscosity measured on the day of the preparation and the viscosity after one week were compared, and an increase in viscosity (unit: mPa·s) was calculated and evaluated according to the following evaluation standard. The results are shown in Table 1 described below.

<<Evaluation Standard>>

AA: The viscosity increase is less than 1.

A: The viscosity increase is from 1 to less than 3.

B: The viscosity increase is 3 or more.

<Production of Heat insulation roll-up curtain, Heat Insulation Window Glass, and Heat Retention Cup>

Using each heat insulation paint, a heat insulation roll-up curtain, a heat insulation window glass, and a heat retention cup were prepared in the following manner.

<Production of Heat Insulation Roll-Up Curtain>

An adhesive solution 1 was prepared with the following formulation.

(Adhesive Solution 1)

Polyurethane for coating (TAKELAC (registered trademark) WS-4000 manufactured by Mitsui Chemicals, Inc., solid content concentration 30%) 5.0 parts

Surfactant (trade name: NAROACTY (registered trademark) HN-100, manufactured by Sanyo Chemical Industries, Ltd.) 0.3 parts

Surfactant (SANDED (registered trademark) BL, solid content concentration 43%, manufactured by Sanyo Chemical Industries, Ltd.) 0.3 parts

Water 94.4 parts

One surface of a polyethylene terephthalate (hereinafter referred to as “PET”) film having a thickness of 75 μm used as a support was subjected to a corona discharge treatment, the above-described adhesive solution 1 was applied to the surface subjected to the corona discharge treatment, dried at 120° C. for 2 minutes, and therefore a first adhesive layer having a thickness of 0.11 μm was formed.

An adhesive solution 2 was prepared with the following formulation.

(Adhesive Solution 2)

Tetraethoxysilane (trade name: KBE-04, manufactured by Shin-Etsu Chemical Co., Ltd.) 5.0 parts

3-glycidoxypropyltrimethoxysilane (trade name: KBM-403, manufactured by Shin-Etsu Chemical Co., Ltd.) 3.2 parts

2-(3,4-epoxycyclohexyl) ethyltrimethoxysilane (trade name: KBM-303, manufactured by Shin-Etsu Chemical Co., Ltd.) 1.8 parts

Acetic acid aqueous solution (acetic acid concentration =0.05%, pH =5.2) 10.0 parts

Curing agent (boric acid, manufactured by Wako Pure Chemical Industries, Ltd.) 0.8 parts

Colloidal silica (SNOWTEX (registered trademark) 0, average particle diameter 10 nm to 20 nm, solid content concentration 20%, pH =2.6, manufactured by NISSAN CHEMICAL INDUSTRIES, LTD.) 60.0 parts

Surfactant (NAROACTY (registered trademark) HN-100, manufactured by Sanyo Chemical Industries, Ltd.) 0.2 parts

Surfactant (SANDED (registered trademark) BL, solid content concentration 43%, manufactured by Sanyo Chemical Industries, Ltd.) 0.2 parts

The adhesive solution 2 was prepared by the following method.

To the vigorously stirred acetic acid aqueous solution, in the following order, 3-glycidoxypropyltrimethoxysilane was added dropwise over 3 minutes, 2-(3,4-epoxycyclohexyl) ethyltrimethoxysilane was added over 3 minutes, and finally tetraethoxysilane was added over 5 minutes. After completion of the addition, stirring was continued for 2 hours. Next, the colloidal silica, the curing agent, and the surfactant were sequentially added to prepare the adhesive solution 2.

After the corona discharge treatment of the surface of the first adhesive layer provided on one surface of the above-described PET film, the adhesive solution 2 was applied to the surface of the first adhesive layer subjected to the corona discharge treatment by a bar coating method, heated at 170° C. for 1 minute, and then dried, and therefore, a second adhesive layer having a thickness of 0.5 μm was formed. As described above, a film having the first adhesive layer and the second adhesive layer in order on one surface of the PET film (hereinafter referred to as “PET substrate attached with the adhesive layers”) was prepared.

The surface of the second adhesive layer of the PET substrate attached with the adhesive layers was subjected to the corona discharge treatment. The heat insulation paint was applied to the surface of the second adhesive layer subjected to the corona discharge treatment by the bar coating method so that an amount of silver becomes 0.040 g/m² and a coating amount of the total solid content becomes 0.280 g/m². After that, the surface was dried at 175° C. for 1 minute to cause a sol-gel reaction, and therefore a heat insulation layer was formed. In this manner, the heat insulation roll-up curtain was obtained.

<Production of Heat Insulation Window Glass>

After washing the surface of a commercially available plate glass with ethanol, the heat insulation paint was applied thereto. After that, the surface was dried at 175° C. for 1 minute to cause the sol-gel reaction, and therefore the heat insulation window glass having a heat insulation layer with a thickness of 0.2 μm was produced.

<Production of Heat Retention Cup>

The heat insulation paint 1 of Example 1 was applied to an outer side of a glass cup of 200 ml. After that, the cup was dried at 175° C. for 1 minute to cause the sol-gel reaction, and therefore the heat retention cup having a heat insulation layer with a thickness of 0.2 μm was produced.

<Evaluation>

(1) Visible Light Transmittance

Transmission spectra of the heat insulation roll-up curtain and the heat insulation window glass produced as described above were measured using an ultraviolet-visible-near-infrared spectrometer (manufactured by JASCO Corporation, V-670, using integrating sphere unit ISN-723), and visible light transmittance was calculated according to JIS R 3106 and JIS A 5759. The results are shown in Table 2 described below.

In practical terms, it is required that the visible light transmittance of the heat insulation window glass is 70% or more, and 80% or more is preferable, and 85% or more is more preferable.

(2) Heat Insulation Property (Heat Transfer Coefficient)

With respect to the heat insulation roll-up curtain and the heat insulation window glass produced as described above, a reflection spectrum was measured in a wavelength range of from 5 μm to 25 μm using the infrared spectrometer (IFS 66v/S, manufactured by Bruker Optics). The heat transfer coefficient was calculated according to JIS A 5759 and the evaluation from the calculated heat transfer coefficient was performed adhesive according to the following evaluation standard. The reflectivity at a wavelength of from 25 μm to 50 μm was extrapolated from the reflectivity at 25 μm according to JIS A 5759. The results are shown in Table 2 below.

<<Evaluation Standard>>

AAA: The heat transfer coefficient is less than 4.5 W/m²·K.

AA: The heat transfer coefficient is from 4.5 W/m²·K to less than 5.0 W/m²·K.

A: The heat transfer coefficient is from 5.0 W/m²·K to less than 5.5 W/m²·K.

B: The heat transfer coefficient is 5.5 W/m²·K or more.

(3) Measurement of Radio Wave Permeability

The radio wave permeability of the heat insulation window glass and the heat insulation roll-up curtain provided with the heat insulation layers by the heat insulation paint of each examples and comparative examples was measured according to a KEC measurement method by the Kansai Electronic Industrial Promotion Center (KEC). In regard to the radio wave permeability, the radio wave attenuation rate [dB] at 0.1 MHz and 2 GHz was measured according to the following formula, and the radio wave permeability was evaluated according to the following standard. The results are shown in Table 2 below.

Radio wave attenuation rate [dB]=20×Log₁₀ (Ei/Et)

(In the above formula, Ei represents an incident field strength [V/m] and Et represents a conduction field strength [V/m].)

<<Evaluation Standard>>

AA: At any frequency, the radio wave attenuation rate is less than 1 dB.

A: At any one frequency, the radio wave attenuation rate is from 1 dB to less than 10 dB.

B: At any one frequency, the radio wave attenuation rate is 10 dB or more.

It can be said that the smaller the radio wave attenuation rate is, the higher the radio wave permeability is.

(4) Changes in Tint of Cup

Changes in tint of the heat retention cup before forming, on the cup, the heat insulation layers by the heat insulation paint of each example and comparative example, and after forming the heat insulation layers thereon, were visually observed and evaluated according to the following evaluation standard. The results are shown in Table 2 below.

<<Evaluation Standard>>

A: The tint hardly changes.

B: The tint changes.

(5) Temperature Rise of Heat Retention Cup

180 ml of water at 5° C. was added to the heat retention cup in which the heat insulation layer was formed by the heat insulation paint of each example and comparative Example, and the cup was left alone at room temperature (25° C.), the temperature change after 10 minutes was measured, and the evaluation was performed according to the following evaluation standard. The results are shown in Table 2 below.

<<Evaluation Standard>>

AA: The temperature change is less than 1° C.

A: The temperature change is from 1° C. to less than 2° C.

B: The temperature change is 2° C. or more.

(6) Microwave Suitability

Water was added to the heat retention cup in which the heat insulation layer was formed by the heat insulation paint of each example and the comparative example, the cup was warmed in a microwave oven, the change at that time was observed, and the evaluation was performed according to the following evaluation standard. The results are shown in Table 2 below.

A: Nothing happens

B: Spark occurs

TABLE 1

| | Heat insulation paint | | | | | | | | | |
|---|---|---|---|---|---|---|---|---|---|---|
| | | Fibrous conductive particles | | | | | | | | |
| | | | | | Ratio of secondary | Binder | | | | |
| | | | | | particle diameter | | Metal coupling | | Surface | |
| | | | | | before and after | | agent having | | electrical | Evaluation |
| | | | | Content of | dilution (average | | functional | | resistance | on coating |
| | | | Average | fibrous | secondary | | group capable | Average | (Ω/square) of | solution |
| | | | long | conductive | particle diameter | | of interacting | transmittance | coated film | Viscosity |
| | | | axis | particles with | a/average | | with fibrous | for far | having film | increase |
| | | Presence or | length | respect to total | secondary particle | | conductive | infrared rays | thickness of | after |
| | No. | absence | (μm) | solid content | diameter b) | Material | particles | (%) | 500 nm | one week |
| Example 1 | 1 | Presence | 10 | 14% | 1.0 | TESi | Added | 75 | OV | AA |
| Example 2 | 2 | Presence | 10 | 27% | 1.4 | TESi | Added | 75 | 1200 | A |
| Example 3 | 3 | Presence | 10 | 20% | 1.2 | TESi | Added | 75 | OV | AA |
| Example 4 | 4 | Presence | 10 | 5% | 0.9 | TESi | Added | 75 | OV | AA |
| Example 5 | 5 | Presence | 4.8 | 14% | 1.0 | TESi | Added | 75 | OV | AA |
| Example 6 | 6 | Presence | 25 | 14% | 1.2 | TESi | Added | 75 | OV | AA |
| Example 7 | 7 | Presence | 55 | 14% | 1.2 | TESi | Added | 75 | OV | AA |
| Example 8 | 8 | Presence | 10 | 14% | 1.1 | COP | Not added | 87 | OV | AA |
| Example 9 | 9 | Presence | 10 | 14% | 1.1 | PAN | Not added | 66 | OV | AA |
| Example 10 | 10 | Presence | 10 | 2% | 0.8 | TESi | Added | 75 | OV | AA |
| Example 11 | 11 | Presence | 10 | 30% | 1.5 | TESi | Added | 75 | 1100 | A |
| Example 12 | 12 | Presence | 10 | 14% | 1.1 | TESi + | Added | 55 | OV | AA |
| | | | | | | 3GPTMSi | | | | |
| Example 13 | 13 | Presence | 10 | 14% | 1.4 | TESi | Not added | 75 | OV | A |
| Example 14 | 14 | Presence | 10 | 14% | 1.1 | TPTi | Not added | 69 | OV | A |
| Example 15 | 15 | Presence | 10 | 14% | 1.0 | TEZr | Not added | 65 | OV | A |
| Comparative | C1 | Presence | 10 | 40% | 2.0 | TESi | Added | 75 | 35 | B |
| Example 1 | | | | | | | | | | |
| Comparative | C2 | Presence | 10 | 1% | 0.6 | TESi | Added | 75 | OV | A |
| Example 2 | | | | | | | | | | |
| Comparative | C3 | Presence | 10 | 14% | 1.6 | PVA | Not added | 31 | 740 | A |
| Example 3 | | | | | | | | | | |
| Comparative | C4 | Absence | — | — | 2.4 | TESi | Added | 75 | OV | B |
| Example 4 | | | | | | | | | | |
| Comparative | C5 | Presence | 10 | 14% | 2.3 | PMMA | Not added | 44 | OV | B |
| Example 5 | | | | | | | | | | |
| Comparative | C6 | Presence | 10 | 14% | 1.7 | TESi + | Added | 46 | OV | A |
| Example 6 | | | | | | 3GPTMSi | | | | |

The abbreviations in Table 1 are as follows.
TESi: Tetraethoxysilane
COP: Cycloolefin polymer
PAN: Acrylonitrile polymer
3GP TMSi: 3-glycidoxypropyltrimethoxysilane
TPTi: Tetrapropoxy titanate
TEZr: Tetraethoxy zirconate
PVA Polyvinyl alcohol

TABLE 2

| | Heat insulation paint | | | | | | | | |
|---|---|---|---|---|---|---|---|---|---|
| | Evaluation on heat insulation roll-up | | | Evaluation on heat insulation window | | | | | |
| | curtain | | | glass | | | | | |
| | | Heat | | | Heat | | | | |
| | | insulation | | | insulation | | Evaluation on heat retention cup | | |
| | | property | | | property | | | Temperature | |
| | Visible light | (heat | | Visible light | (heat | | | rise in | |
| | transmittance | transfer | Radio wave | transmittance | transfer | Radio wave | Tint | solution of | Microwave |
| No. | (%) | coefficient) | permeability | (%) | coefficient) | permeability | change | cup | suitability |
| 1 | 88 | AAA | AA | 90 | AAA | AA | A | AA | A |
| 2 | 87 | AAA | A | 89 | AAA | A | A | AA | A |
| 3 | 87 | AAA | AA | 89 | AAA | AA | A | AA | A |
| 4 | 87 | A | AA | 89 | A | AA | A | A | A |
| 5 | 88 | A | AA | 90 | A | AA | A | A | A |
| 6 | 87 | AA | AA | 89 | AA | AA | A | AA | A |
| 7 | 88 | A | AA | 90 | A | AA | A | A | A |
| 8 | 86 | A | AA | 88 | A | AA | A | A | A |
| 9 | 85 | A | AA | 84 | A | AA | A | A | A |
| 10 | 87 | A | AA | 87 | A | AA | A | A | A |
| 11 | 88 | AA | A | 87 | AA | A | A | AA | A |
| 12 | 86 | A | AA | 88 | A | AA | A | A | A |
| 13 | 87 | AAA | AA | 88 | AAA | AA | A | AA | A |
| 14 | 86 | AA | AA | 87 | AA | AA | A | AA | A |
| 15 | 85 | AA | AA | 85 | AA | AA | A | AA | A |
| C1 | 87 | AAA | B | 89 | AAA | B | A | AA | A |
| C2 | 86 | B | AA | 88 | B | AA | A | B | A |
| C3 | 86 | B | B | 88 | B | B | A | B | B |
| C4 | 68 | B | AA | 69 | B | AA | B | B | A |
| C5 | 84 | B | AA | 83 | B | AA | A | B | A |
| C6 | 85 | B | AA | 84 | B | AA | A | B | A |

From the results of Tables 1 and 2, the following can be understood.

The heat insulation paint according to the embodiment of the present invention has excellent storage stability.

The higher the far-infrared transmittance of the binder of the heat insulation paint is, the higher the heat transfer coefficient is, and therefore, the heat insulation layer having excellent heat insulation property can be obtained.

The heat insulation paint according to the embodiment of the present invention provides the heat insulation layer having excellent radio wave permeability. Therefore, the heat insulation roll-up curtain, the heat insulation window glass, and the like produced by using the heat insulation paint according to the embodiment of the present invention do not cause a problem in telephone conversation through mobile phones, and even if the heat insulation paint are used for forming the heat insulation layer of the heat retention cup, the paint causes no problem in heating by the microwave oven.

The disclosure of JP2015-152473A filed on Jul. 31, 2015 is hereby incorporated by reference in its entirety.

All documents, patent applications, and technical standards described in the present specification are hereby incorporated by reference of the present specification in their entirety to the same extent as in a case where each individual document, patent application, and technical standard were specifically and individually indicated to be incorporated herein by reference.

What is claimed is:

1. A heat insulation paint, comprising:
fibrous conductive particles; and
a binder that would exhibit an average transmittance of 50% or more for far infrared rays having a wavelength of 5 μm to 25 μm when the binder is formed into a coated film having a film thickness of 2 μm,
wherein a content of the fibrous conductive particles with respect to a total solid content is from 2% by mass to 30% by mass.

2. The heat insulation paint according to claim 1, wherein the heat insulation paint would exhibit a surface electrical resistance thereof of 1000Ω/square or more when the heat insulation paint is formed into a coated film having a film thickness of 500 nm.

3. The heat insulation paint according to claim 1, wherein an average long axis length of the fibrous conductive particles is from 5 μm to 50 μm.

4. The heat insulation paint according to claim 3, wherein an average long axis length of the fibrous conductive particles is from 5 μm to 20 μm.

5. The heat insulation paint according to claim 1, wherein a content of the fibrous conductive particles is from 5% by mass to 25% by mass with respect to the total solid content.

6. The heat insulation paint according to claim 1, wherein the binder includes at least one inorganic oxide binder selected from silicon oxide, zirconium oxide, titanium oxide, or aluminum oxide, or a content of the inorganic oxide binder exceeds 50% by mass with respect to the total content of the binder contained in the heat insulation paint.

7. The heat insulation paint according to claim 1, wherein the binder includes at least one organic polymer binder selected from polycycloolefin or polyacrylonitrile, and a content of the organic polymer binder exceeds 50% by mass with respect to the total content of the binder contained in the heat insulation paint.

8. The heat insulation paint according to claim 1, further comprising a metal coupling agent having a functional group capable of interacting with the fibrous conductive particles.

9. The heat insulation paint according to claim 1, wherein when the heat insulation paint is diluted 10-fold, a ratio of an average secondary particle diameter a of the fibrous conductive particles before dilution to an average secondary particle diameter b of the fibrous conductive particles after dilution would be from 0.8 to 1.2.

10. The heat insulation paint according to claim 1, wherein fibrous conductive particles include silver nanowires.

11. The heat insulation paint according to claim 1, wherein the fibrous conductive particles include at least one selected from the group consisting of fibrous metal particles, carbon nanotubes, and conductive resins.

12. The heat insulation paint according to claim 1, wherein an aspect ratio of the fibrous conductive particles is from 10 to 100000.
